(19) United States
(12) Patent Application Publication
(10) Pub. No.: US 2023/0033194 A1
(43) Pub. Date: Feb. 2, 2023

(54) RESONATOR RING FOR COMBUSTION CHAMBER SYSTEMS

(71) Applicant: Siemens Energy Global GmbH & Co. KG, Munich, Bayern (DE)

(72) Inventors: Matthias Gralki, Mulheim an der Ruhr (DE); Claus Krusch, Essen (DE)

(73) Assignee: Siemens Energy Global GmbH & Co. KG, Munich, Bayern (DE)

(21) Appl. No.: 17/791,737

(22) PCT Filed: Dec. 21, 2020
(86) PCT No.: PCT/EP2020/087425

§ 371 Date: Jul. 8, 2022

(30) Foreign Application Priority Data
Jan. 20, 2020 (DE) 10 2020 200 583.4

(51) Int. Cl. F23R 3/46; F23R 3/00

(52) U.S. Cl. CPC F23R 3/46; F23R 3/002; F23R 2900/00018; F23R 2900/00014; F05D 2220/32; F05D 2260/963

(57) ABSTRACT

A resonator formed as a ring for a gas turbine combustion chamber, includes an outer shell and an inner shell, wherein one part of a hot gas channel of the gas turbine combustion chamber is delimited by the inner shell, wherein at least one Helmholtz resonator is arranged between the outer shell and the inner shell.

### CROSS REFERENCE TO RELATED APPLICATIONS

This application is the US National Stage of International Application No. PCT/EP2020/087425 filed 21 Dec. 2020, and claims the benefit thereof. The International Application claims the benefit of German Application No. DE 10 2020 200 583.4 filed 20 Jan. 2020. All of the applications are incorporated by reference herein in their entirety.

### FIELD OF INVENTION

The invention relates to the resonator region of combustion chamber systems of the kind used particularly in stationary gas turbines and the combustion chamber systems thereof.

### BACKGROUND OF INVENTION

Tubular combustion chamber systems of stationary gas turbines generally consist of one or more combustion chamber components connected axially in series between the burner outlet and the turbine inlet. Thus, some tubular combustion chamber types made by Siemens Energy have a system consisting of a basket and a transition. This system carries the combustion gases from the burner in the direction of the turbine inlet. Owing to the high combustion temperatures, the tubular combustion chamber components are usually based on thin-walled Ni-based superalloys with internal cooling channels and a layer system for thermal insulation (NiCoCrAlY-TBC).

In or downstream of the flame region, tubular combustion chamber systems have circumferentially arranged resonators in order to reduce acoustic combustion oscillations.

The production of the resonators is complex and expensive.

The resonator region has relatively large cooling air surfaces and is intensively cooled or flowed through. In this respect, the cooling air requirement is relatively high in relation to the overall tubular combustion chamber system.

### SUMMARY OF INVENTION

It is therefore an object of the invention to solve the abovementioned problem of cooling air consumption.

The object is achieved by a resonator and a tubular combustion chamber as claimed.

The dependent claims list further advantages which can be combined with one another as desired in order to achieve further advantages.

The resonator according to the invention forms a ring which consists of a, in particular, additively manufactured, double cylinder with closed cooling and resonators arranged within the annular gap.

A perforated absorber replaces the metallic resonator with open cooling in the region of a tubular combustion chamber.

In contrast to conventional resonators with open cooling, through which flow occurs radially (with respect to the burner axis) (“perforated combustion chamber wall”), a more or less large proportion of the compressor mass flow emerging into the burners flows axially through the resonator annular channel of the resonator according to the invention.

In contrast to the resonator with open cooling, the system is cooled purely by convection and without cooling air consumption, by means of volumetrically separate cooling air flow, in a manner similar to that in a heat exchanger. Particularly in the region of the inner plate facing the hot gas and in the region of the resonator neck outer surfaces, a high heat transfer to the cooling air mass flow is required. The high heat transfers can be ensured by an appropriate configuration of the flow velocities or mass flows through the resonator, i.e. by adaptation of the flow cross sections of the perforated burner plate and of the resonator inlet cross section.

In addition, measures to improve the heat transfer at the outer surfaces of the resonator neck, such as ribs or “dimples”, can be used to increase the surface area.

The invention comprises both one-piece and circumferentially and/or axially segmented and welded embodiments.

The resonant frequency is determined by appropriate geometric configuration of the inert air mass determined by the resonator neck length and diameter, as well as the size of the air volume arranged behind it.

A wide range of resonator geometries and embodiments can be produced on the basis of additive manufacture, taking into account the manufacturing-specific requirements.

The claim according to the invention relates, in particular, to an

a) annular channel which is in one piece or segmented in the circumferential direction,
b) resonator volumes located within the annular channel and having common side walls or side walls separated by gaps,
c) with resonator volumes located within the annular channel and having a cuboidal, spherical or other, more complex, spatial geometry,
d) with resonator volumes located within the annular channel which have one or more resonator necks opening into the hot gas path,
e) with resonator volumes located within the annular channel and having a (radially) outer wall which is part of the annular channel outer plate or is connected to the annular channel outer plate via connecting elements.

The proposed system of a resonator, in particular an additively manufactured resonator, replaces the welded construction of the resonator system of a tubular combustion chamber.

The advantages include:—Reduction of production and life cycle costs, potential: through—geometry with internal cavities and flow channels which can be produced additively at low cost—Increasing the maintenance intervals through improved service life as a result of a reduction in temperature gradients—Reducing the cooling air requirement in comparison with radial-flow metallic resonators, potential:—Transferability to tubular combustion chamber systems from various competitors.

It is, in particular, common to all the embodiments that the resonator volumes have only openings to the internal diameter or connections to the hot gas channel of the combustion chamber.

### BRIEF DESCRIPTION OF THE DRAWINGS

In the drawings:

FIGS. 1 and 8 show a tubular combustion chamber,

FIG. 2 shows a resonator ring,

FIGS. 3-7 show resonator volumes.

### DETAILED DESCRIPTION OF INVENTION

The figures and the description represent only exemplary embodiments of the invention.

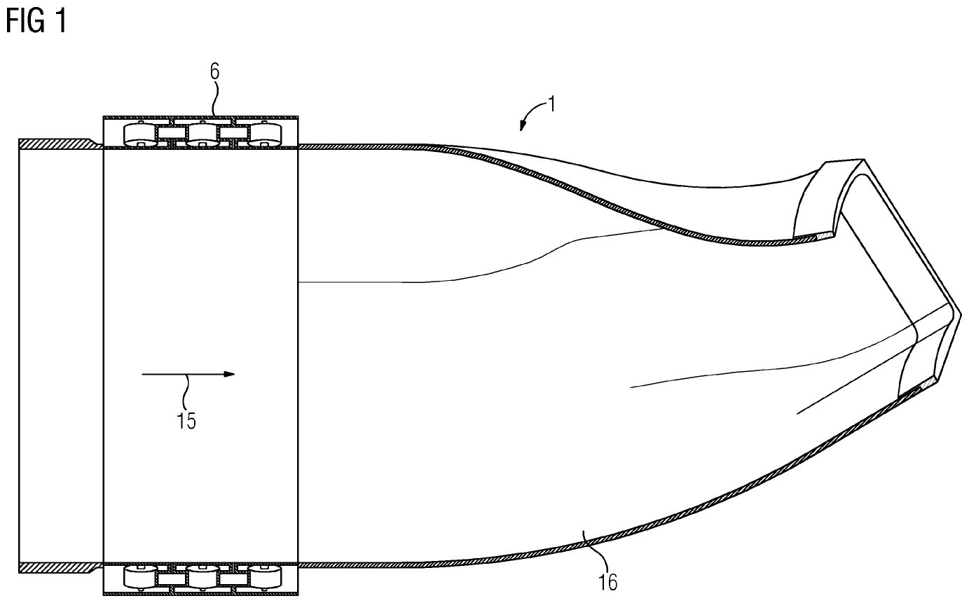

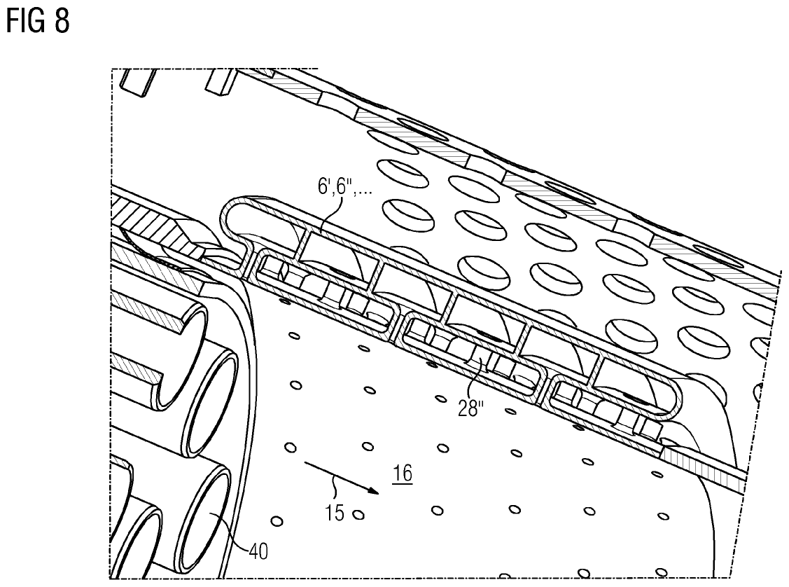

FIGS. 1 and 8 schematically illustrate part of a tubular combustion chamber 1.

In the interior of the tubular combustion chamber 1, that is to say in the hot gas channel 16 of the tubular combustion chamber 1, hot gas flows in the chamber flow direction 15 to the turbine.

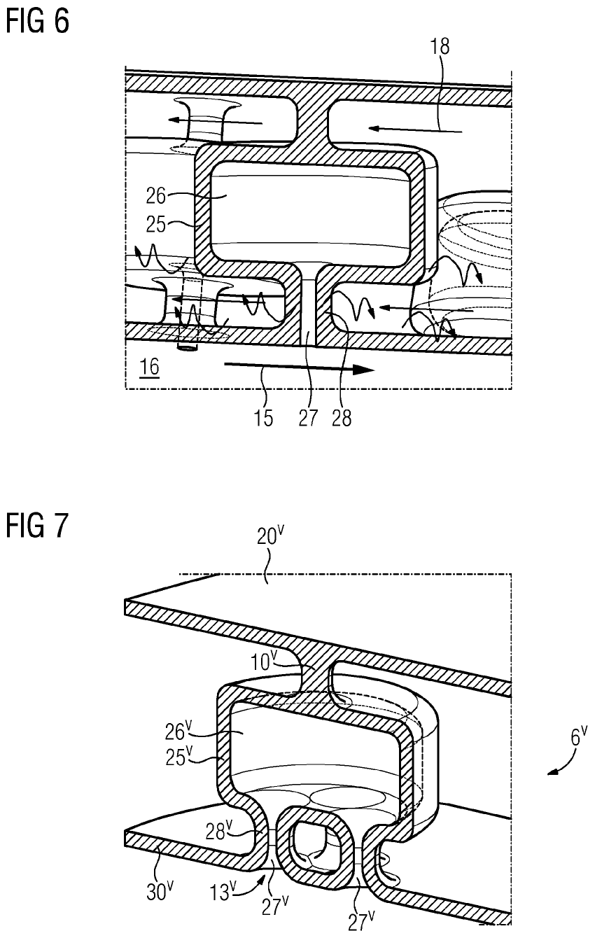

The tubular combustion chamber 1 has, along and around the hot gas channel 16 of the tubular combustion chamber 1, in an axial section, a resonator 6, in which cooling air 19 (FIG. 6), in particular from the compressor, advantageously flows counter to the direction of flow of the chamber 15.

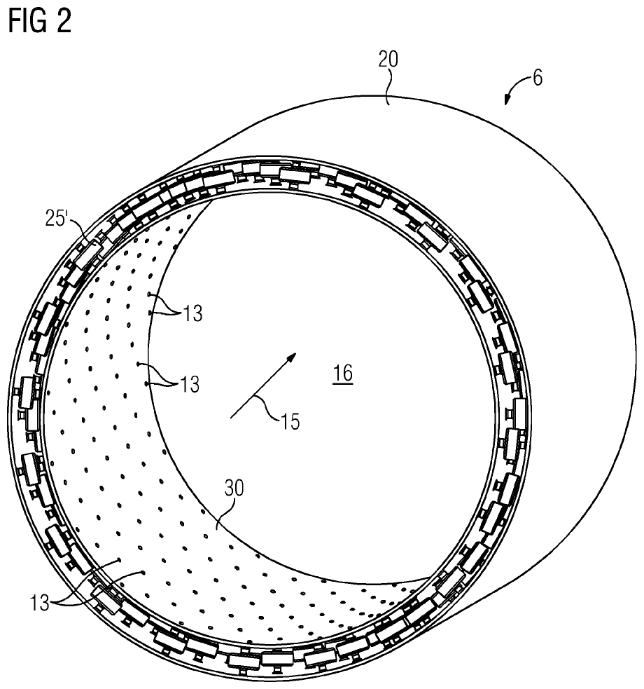

The resonator 6 is advantageously of annular design. In this case, the cooling air flows around resonators (FIGS. 2-8), as illustrated in the figures below.

FIG. 2 shows an illustrative resonator 6 according to FIG. 1. The resonator 6 in the form of a ring can be of one-piece or segmental construction.

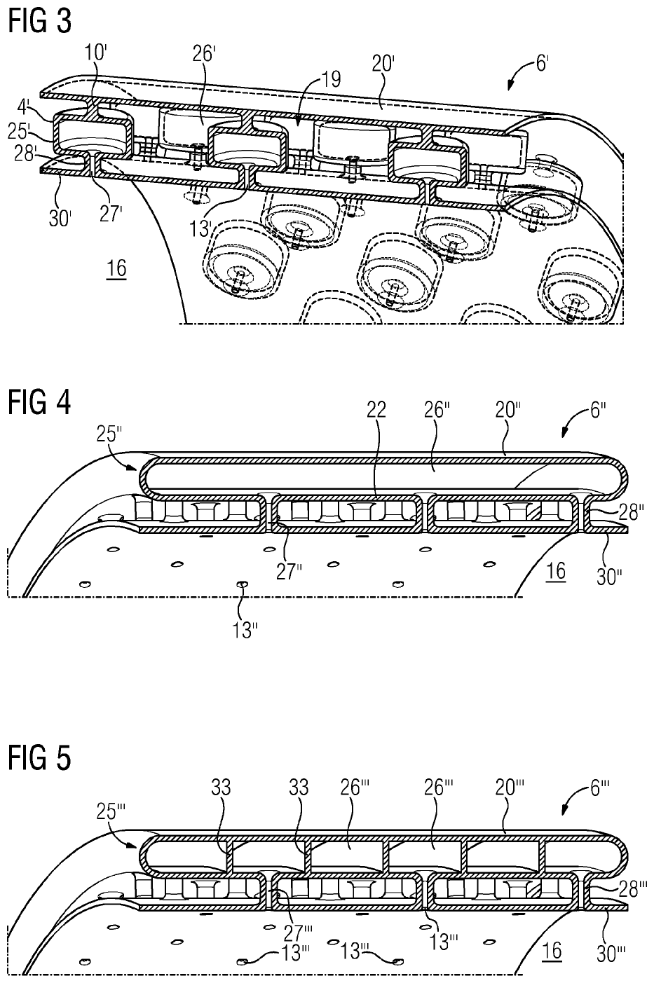

Between an outer shell 20 and an inner shell 30, the resonator 6 has a closed cooling system with Helmholtz resonators 25′, 25″, . . . (FIG. 3ff).

It is also possible to see openings 13 of the Helmholtz resonators 25′ to the hot gas channel 16 of the tubular combustion chamber 1.

The hot air from the burner 40 (FIG. 8) flows in the chamber flow direction 15 to the turbine, whereas the cooling air 19 (FIG. 6) flows in the cooling air flow direction 18 (FIG. 6) in the resonator 6, counter to the chamber flow direction 15.

FIG. 3 shows a first further detail of FIG. 2 and discloses a cross section through an illustrative resonator 6′ and a first exemplary embodiment of Helmholtz resonators 25′, which is or are present between the outer shell 20′ and the inner shell 30′, between which the cooling air 19 flows. The Helmholtz resonators 25′ are present between the outer shell 20′ and the inner shell 30′.

The cooling air 19 flows around the individual Helmholtz resonators 25′ from all sides.

The hollow body 26′ of the Helmholtz resonator 25′, formed by a wall 4′, is here spaced apart from the outer shell 20′ and the inner shell 30′.

Preferably round, disk-shaped hollow bodies 26′ form the Helmholtz resonator 25′.

The Helmholtz resonator 25′ is connected to the outer shell 20′ via a web 10′, which is, in particular, solid.

The cavity 26′ of the Helmholtz resonator 25′ is furthermore connected by a channel 27′, in particular a channel 27′ of annular cross section, of a neck 28′ to the hot gas channel 16 of the tubular combustion chamber 1, which is formed by the inner shell 30′, via an opening 13′.

The diameters of the web 10′ and/or of the neck 28′ to which the Helmholtz resonators 25′ are connected between the two shells 20′, 30′ are clearly different from the diameter of the hollow body 26′. The ratio of the diameters is advantageously at least 3:1 for diameters of hollow body 26′ to neck 28′ or web 10′.

A large number of individual Helmholtz resonators 25′ is arranged in the circumferential direction of the resonator 6′.

As also illustrated in FIG. 3, there is always a sufficient gap between individual Helmholtz resonators 25′ in an axial direction, parallel to the chamber flow direction 15, and the distance is advantageously greater than the diameter of the Helmholtz resonator 25′. For this purpose, advantageously radially offset, further Helmholtz resonators 25′ are then arranged so as to be axially offset.

Other arrangements of the individual Helmholtz resonators 25′ are possible.

FIG. 4 shows a further exemplary embodiment having a resonator 6″, here advantageously designed as a ring, which has a single common cavity 26″ as a Helmholtz resonator 25″.

Between the outer shell 20″ and the inner shell 30″, there is, as it were, an intermediate shell 22, which represents the large common cavity 26″ over the width of the resonator 6″.

Starting from the one cavity 26″ of the resonator 6″, there are a large number of channels 27″ to the hot gas channel 16 of the tubular combustion chamber 1, which in turn are each formed by necks 28″, advantageously like the necks 28′ of the Helmholtz resonators 25′ in FIG. 3.

A single, large cavity 26′″ is thus connected to the hot gas channel 16 by means of a large number of necks 28″.

The necks 28″ can be constructed and distributed like the necks 28′ according to FIG. 3.

FIG. 5 shows a further exemplary embodiment of a resonator 6′″, in which there are segmented cavities 26′″, which are formed, as it were, on the basis of FIG. 4, by partition walls 33 inside the cavity 26′″ (FIG. 4). A plurality of annular cavities 26′″ is, as it were, arranged in series in the axial direction 15.

The necks 28′″ can be distributed like the necks 28′ according to FIG. 3 or 4.

Likewise, there is a plurality of channels 27′″ per cavity 26′″.

FIG. 7 shows a cavity 26^{V} which has two channels 2D in a neck 28^{V}.

Such Helmholtz resonators 25^{V} can be used singly, in multiples or completely for the resonator 6^{V}.

In comparison with FIG. 3, the neck 28^{V} has two or more channels 2′7^{V}.

It is clear that further exemplary embodiments are encompassed by the invention since the description, figures and exemplary embodiments represent the invention.

This geometry is advantageously produced by an additive production method such as a powder bed method, in particular a laser sintering method and a laser melting method. Restriction to these specific additive manufacturing methods is not specified and are conceivable.

FIG. 8 shows the installation situation of a resonator 6′″ according to FIG. 5 in a tubular combustion chamber.

1. A resonator, comprising:
an outer shell and an inner shell,
wherein one part of a hot gas channel of the tubular combustion chamber is delimited by the inner shell,
wherein at least one Helmholtz resonator is present between the outer shell and the inner shell.

2. The resonator as claimed in claim 1,
comprising a large number of Helmholtz resonators.

3. The resonator as claimed in claim 1,
wherein there is a single Helmholtz resonator having only one cavity.

4. The resonator as claimed in claim 1,
wherein there is a single Helmholtz resonator having a plurality of resonator volumes due to partition walls.

5. The resonator as claimed in claim 1,
wherein, for each resonator, there is one web as a connection to the outer shell.

6. The resonator as claimed in claim 1,
wherein respective resonator volumes have one or more channels toward the inner shell and thus have connections to a hot gas channel of a tubular combustion chamber.

7. The resonator as claimed in claim 1,
wherein there is only one channel per cavity and only one neck per Helmholtz resonator to a hot gas channel of a tubular combustion chamber.

8. The resonator as claimed in claim 1,
wherein there is a plurality of channels per cavity to a hot gas channel of a tubular combustion chamber.

9. The resonator as claimed in claim 1,
wherein there is only one neck per Helmholtz resonator.

10. The resonator as claimed in claim 1,
wherein there is a plurality of necks for a cavity.

11. The resonator as claimed in claim 1,
wherein there is a plurality of channels and only one neck for a cavity.

12. The resonator as claimed in claim 1,
which is produced by an additive method.

13. The resonator as claimed in claim 1,
further comprising dimples on inner surfaces of the inner and outer shells.

14. A tubular combustion chamber, comprising:
a resonator as claimed in claim 1.

15. The resonator as claimed in claim 1,
wherein the resonator is designed as a ring.

16. The resonator as claimed in claim 1,
wherein the resonator is designed for a tubular combustion chamber.

17. The resonator as claimed in claim 16,
wherein the resonator is designed for a gas turbine.

18. The resonator as claimed in claim 5,
wherein, for each resonator, there is only one web.
